(19) United States
(12) Patent Application Publication
(10) Pub. No.: US 2018/0134383 A1
(43) Pub. Date: May 17, 2018

(54) DECENTRALIZED REDUNDANT ARCHITECTURE FOR AN UNMANNED AIRCRAFT FOR SIMPLIFIED INTEGRATION OF SENSOR SYSTEMS

(71) Applicant: Hochschule für Angewandte Wissenschaften Hamburg, Hamburg, OT (DE)

(72) Inventor: Stephan Schulz, Bremen (DE)

(73) Assignee: Hochschule für Angewandte Wissenschaften Hamburg, Hamburg, OT (DE)

(21) Appl. No.: 15/510,308

(22) PCT Filed: Sep. 11, 2015
(86) PCT No.: PCT/EP2015/070879

§ 371 Date: Sep. 11, 2017

(30) Foreign Application Priority Data
Sep. 12, 2014 (DE) 10 2014 113 191.6

(51) Int. Cl. B64C 39/02

(52) U.S. Cl. CPC B64C 39/024; B64C 2201/027; B64C 2201/042; B64C 2201/127; B64C 2201/108

(57) ABSTRACT

An unmanned aircraft includes a plurality of drive modules arranged in a decentralized manner, wherein each drive module has a plurality of aircraft components. The unmanned aircraft further has a payload sensing system consisting of a sensor system including one or a plurality of sensor units in such a way that the solid angle for capturing measuring data is increased and the flight safety of the aircraft is improved simultaneously. The sensor units are centrally arranged in the form of the sensor system.

The invention relates to an unmanned aircraft comprising a plurality of drive modules arranged in a decentralized manner, wherein each module has a plurality of aircraft components, the arrangement of which is described by means of a modular and redundant system architecture. The unmanned aircraft further has one or a plurality of centrally arranged sensor units, which act independently from one another or connected to one another as sensor system. The spatially excellent arrangement results in a simplified integration of the sensor system with regard to the desired operating parameters

### PRIOR ART

The system architecture of unmanned aircrafts (UAV), in particular of miniaturized unmanned aircrafts, generally provides a flight control, electronics and power supply, which is centralized in a spatial configuration. The operative flightworthiness of the UAV is prioritized as compared to the integration of a passive or active payload and the operation in the form of a sensor system consisting of one or a plurality of functional sensor units.

The system design of UAV is generally determined by the design specifications relating to aerodynamics and avionics. The sensor system consisting of one or a plurality of sensor units as payload is thereby secondary to the design specifications of the aircraft in terms of design and operation. Functional parameter ranges for the optimal use of the sensor units can thus only be attained to a limited extent or with additional technical effort, always at the expense of the performance of the overall system. As an example, reference shall be made to the limitation of the solid angle of an optical sensor unit as payload sensing system by one-sided mounting. Further mechanical or optronic adjusting units widen the functional parameter range, but reduce the payload capacity with respect to mass and power supply, but the effective solid angle coverage in general remains limited to the upper/lower half space. At the same time, additional effort is created in the system architecture with regard to the continuous control in the operative mode.

FIG. 1 shows a multi-rotor aircraft known from the prior art as unmanned aircraft, which is embodied as a quadrocopter. A sensor unit in the form of a camera is positioned below the centrally arranged aircraft components in an exemplary manner.

A rotational speed-controlled helicopter is described in DE 10 2005 010 336 A1. The rotational speed-controlled helicopter has three or more lifting units, each comprising at least one rotor and at least one electronically commutated direct current motor, which drives the rotor. To detect the rotational movement, provision is made for a sensor for at least one lifting unit or all lifting units.

A vertical takeoff and landing aircraft for transporting persons or loads comprising a plurality of electric motors and propellers is described in DE 20 2012 001 750 U1, wherein each propeller is assigned an individual electric motor for driving the propeller.

WO 2008/147484 A1 describes an aircraft, which can be coupled to containers, land vehicles, sea vehicles, modules for medical transport, etc. The aircraft described therein has a plurality of propellers, which are positioned around a frame and create thrust in vertical and/or horizontal direction.

WO 2013/174751 A2 describes a method for controlling an aircraft in the form of a multi-rotor aircraft as well as a corresponding control system. The multicopter described therein has a plurality of rotors, in order, on the one hand, to generate lift, and, on the other hand, also propulsion by inclining the at least one rotor plane, wherein the regulation of the position and the control of the multicopter are carried out by changing rotor rotational speeds as a function of pilot control instructions. The rotors have individual controllers and control units in parallel operation, which record, process, evaluate and operate all data simultaneously.

### Disclosure of the Invention: Object, Solution, Advantages

It is the object of the invention at hand to provide an unmanned aircraft (UAV) comprising a modular system architecture and redundant system components, which integrates the payload in a structurally central manner, so as to thus attain a solid-angle optimized positioning for data capturing for the sensor units, which, in their entirety, operate as sensor system. The decentralized and redundant arrangement of the modular aircraft components provides for the quick exchange of essential system components for maintenance and the reconfiguration of the entire aircraft by exchanging components of the aircraft, so as to change or expand, respectively, the range of applications. The exchange is ensured by means of defining simple and a few mechanical interfaces, which are simultaneously also embodied as electronic interfaces.

According to the invention, an unmanned aircraft (UAV) comprising a plurality of drive modules arranged in a decentralized manner is proposed for this purpose. Every drive module has a plurality of aircraft components. As payload, the unmanned aircraft has a sensor system consisting of one or a plurality of sensor units, which are independent or connected to one another. According to the invention, the sensor system is arranged in a structurally central manner.

The aircraft can be embodied as multi-rotor aircraft. The unmanned aircraft can further also be embodied as winged aircraft with or without a rotor by means of reconfiguration. The plurality of drive modules can be embodied, for example, as rotor arms of a multi-rotor wing system or as individual airfoil or as a set of a plurality of airfoils, respectively, of a winged aircraft.

Aircraft components can be, for example, a control electronics, a motor, a power source, a proximity sensor, a satellite positioning system, an inertial measuring system or a computing unit.

The sensor system consisting of a sensor unit or a plurality of sensor units, in turn, can have one or a plurality of sensors. The sensor unit can furthermore also have further means, for example sensors for data capturing and/or processing, for example for pattern recognition. The sensor unit can further also have a memory for storing the determined data and an electronics for wireless data transmission, independent from the aircraft. The data captured by the sensor unit can be further processed within the sensor unit and/or can be transmitted to an external base station via a transmitter.

A central arrangement of the sensor unit is to be understood in such a way that the sensor unit is centrally arranged between the individual drive modules. It is further to be understood hereby that the sensor unit is not mounted above/below or laterally to the geometric center point or center of gravity, as in the case of unmanned aircrafts known from the prior art, but in fact forms the center of the unmanned aircraft. The sensor unit is preferably substantially arranged on a horizontal plane with the drive modules. Provision is further preferably made for a symmetrical arrangement of the sensor unit, wherein the sensor unit is arranged about a center of mass in the geometric center point of the unmanned aircraft. A highly advantageous flight stability can be attained through this. A substantially identical view angle in the upper and lower area or upwards and downwards, respectively, further results from this.

A solid angle, which is significantly larger than the half space, can be attained for the sensor units by arranging the sensor unit in the center. One approach of the invention at hand can also be seen in that the flight design is not prioritized in the design area, as in the case of the unmanned aircrafts known from the prior art, but a system architecture, which prioritizes the payload sensing system and adapts the properties of the aircraft thereto. Far better possibilities with regard to a larger and more varied range of applications are made possible through this.

The unmanned aircraft according to the invention thus provides a novel system architecture, wherein the payload sensing system is prioritized as main object of the unmanned aircraft and a variable usability of the sensor system is simultaneously at hand by means of a quick exchange, an increased safety as a result of redundancy of the aircraft components and a good maintainability of the entire system.

The sensor system can be designed in such a way that sensor units for the optical detection are integrated in different optical spectral ranges, for the detection of gaseous chemicals and for the detection of other measured variables, such as temperature, gas pressure or also electromagnetic fields for the solid angle-resolved measured value capturing.

The sensor unit is preferably embodied and arranged in such a way that an angle of at least 180 degrees, particularly preferably of at least 270, as well as most preferably of 360 degrees can in each case be captured through this in horizontal direction as well as in vertical direction. A virtually complete solid angle in horizontal and in vertical direction, in which data can be captured, results from this.

Provision is furthermore preferably made for the controller of the unmanned aircraft to be embodied so as to be redundant. For this purpose, each drive module preferably has the same aircraft components. The decentralized and redundant arrangement of the aircraft components combines the advantages of lower production costs by means of identical components and the increase of the operational safety by means of redundantly available system components, which are critical for the flight operation.

Each drive module preferably has identical aircraft components of the unmanned aircraft, wherein all drive modules are substantially embodied identically. Provision is thus particularly preferably made for the unmanned aircraft not to have central or centrally arranged aircraft components, respectively. Identical system components in the individual drive modules, for example rotor arms or airfoils, ensure a high redundancy of the aircraft components. When exchanging a rotor arm, redundant aircraft components are replaced simultaneously. In the operative area, the downtime for the unmanned aircraft is reduced, maintenance is simplified and error sources are minimized. Power sources arranged in a decentralized manner further increase the safeguard against failure of the aircraft during operation by means of a secured landing with reduced power supply in case of failure.

Provision is preferably further made for the initialization of the entire unmanned aircraft to be carried out together with a build-in-test (BIT), a self-test module. Here, all redundant aircraft components are initially equal. By means of an internal scheme, the aircraft components determine independently, which aircraft component operates as a matter of priority. The order of the other aircraft components is also determined in order to ensure a quick reaction in case of failure. Such a routine, which is provided preferentially, of initialization and BIT, can already be started during the assembly of the unmanned aircraft, for example. The aircraft component comprising the first runtime stamp after turning on the voltage supply, for example after fastening the rotor arm to the sensor unit, can receive priority, for example, After a BIT, all aircraft components can be found and checked, so as not to obtain an electronic clearance for operation until then.

Provision is preferably furthermore made for each drive module to have a motor, a power source, a proximity sensor, a satellite positioning system, an inertial measuring system, a control electronics and/or a computing unit comprising data processing and communications interfaces. The motor can be embodied as electric motor, for example. The power sources can be provided by means of batteries or other energy storages, for example accumulators. Each drive module preferably has all of these above-mentioned aircraft components.

The payload sensing system, i.e. the sensor system consisting of at least one sensor unit, is preferably functionally decoupled from the aircraft components, particularly preferably from all aircraft components. Provision is thus preferably made for no logical or functional connection to exist between the sensor unit and the aircraft components, which can interfere directly with the flight control. The flight control electronics is thus preferably also separated from the sensor system, so as to avoid interferences or mutual influencing. The entire electronics and mechanism required for the flight or for controlling the flight, respectively, is arranged on or in the drive modules, which are arranged outside of the sensor unit. By functionally separating the aircraft components from the payload sensing system, interferences are avoided. For example, the registration of the unmanned aircraft can be facilitated through this. Changes to the payload sensing system can further be made independently and logically separated from the aircraft, without changing the aircraft thereby.

The payload sensing system includes the sensor system and thus the sensor unit(s). The payload sensing system further preferably has coupling units, via which the drive modules can be mechanically coupled to the payload sensing system. The drive modules are thus mechanically connected in a fixed manner to the payload sensing system via these coupling units. The coupling units, which, as standardized interfaces, can preferably be embodied as part of a frame, thus serve to hold the drive units on the payload sensing system.

Provision is further preferably made for the payload sensing system to have an electric connecting means for electrically coupling the aircraft components, which are assigned to the different drive modules. The aircraft components are thus connected to one another across the drive modules. The electric connecting means can thereby be embodied as bus system, for example. Provision is thus preferably made for the electric connecting means, which electrically connects the individual aircraft components to one another in or on the different drive modules, to be arranged on the payload sensing system. By providing a bus system, the drive modules can be changed or exchanged, respectively, in a simple manner. Due to the fact that all aircraft components of all drive modules are preferably connected to one another via a central electric connecting means, the modularity of the entire system as well as the redundancy is ensured. For example, in case of failure of an individual power supply unit, the assigned motor can be fed from power sources on or in other drive units across the drive modules. In case of failure of an aircraft component, the safety is thus increased significantly as compared to an individual central power source.

Provision is preferably furthermore made for the coupling units to also be embodied for electrically coupling the aircraft components of a drive module to the electric connecting means. For this purpose, the coupling units can be embodied for example as plug and/or screw connecting units comprising electric contacts or electric connectors, respectively. The coupling units are thereby particularly preferably embodied as quick fastening units. The coupling units are thus preferably electrically connected to one another via the electric connecting means and represent electric docking positions for connecting the drive units or the aircraft components assigned to the drive units, respectively. By means of the modular setup, the mechanical interfaces, namely the coupling units, are designed for a quick fastening of the corresponding drive modules, for example rotor arms or airfoils, so as to immediately replace parts of the aircraft without tools in the case of failure. A standardized mechanical interface, which is preferably provided, provides for the quick change of the payload sensing system for the unmanned aircraft for operation in different scenarios.

The coupling units are further preferably embodied in such a way that a plurality of drive modules can in each case be coupled to the payload sensing system via a coupling unit. For example, provision can be made for this purpose for Y-connectors for connecting two drive modules each via a coupling unit. As needed, more or fewer drive modules can thus be used. For example, a four-rotor system can thus be configured into an eight-rotor system in a simple manner. Different configuration of the aircraft can thus be realized in a simple manner on the basis of the same system, so as to reach larger payloads or longer flight times, for example.

The payload sensing system preferably has a frame, wherein the frame is at least sectionally, as well as particularly preferably completely arranged around the sensor system, for example an optical sensor as part of a sensor unit, and holds said sensor. The sensor system, for example the optical sensor or sensor head, respectively, can thereby be fastened inside the frame, wherein the frame thus forms a support for the sensor system. The coupling units and/or the electric connecting means can be arranged in or on the frame. The coupling units can be arranged on the frame of the payload sensing system so as to be distributed circumferentially around the sensor system. Particularly preferably, quick fastening units for mechanical and electrical coupling of the drive modules, for example of the rotor arms or airfoils, are arranged circumferentially on the frame. The frame serves to receive the sensor system and also to electrically connect the individual quick fastening units among one another. Provision is not made for a central electronics.

To generate the redundancy, each individual drive module has a control electronics. Each control electronics is preferably embodied in a self-configuring manner. I.e., the redundant control electronics of each drive module initializes itself and monitors the operation independently. Provision is thereby preferably not made for an evaluation, for example by average or median determination, of all sensors. Each sensor, for example each proximity sensor, runs along independently. In case of failure or if an implausibility is determined, a prioritization can be distributed anew.

According to the invention, provision is further made for the use of an unmanned aircraft according to one of claims 1 to 11 for uses in different areas. For example, the unmanned aircraft can be used for data capturing, in particular image data and/or measuring data capturing. The unmanned aircraft can furthermore be used for object examination and/or object monitoring.

The unmanned aircraft according to the invention, in particular with its preferred features, can be produced cost-efficiently with optimized system components and completely integrated and testable flight electronics. To increase the flight safety, provision is made for a redundancy of the aircraft components, which are important for the flight operation. The center of the unmanned aircraft is reserved completely for the payload sensing system and thus for the measuring sensor system, so that a maximum solid angle can be attained for data capturing.

The redundant aircraft components arranged in a decentralized manner can nonetheless be operated centrally. An aircraft component can be provided as master, for example, wherein the other aircraft components operate as slave in energy saving mode and only become active, if error states of the master occur on the data bus. Provision is furthermore made for a simplified maintainability by assembly or disassembly, respectively, of the aircraft components on the frame of the sensor unit, wherein no tool and special knowledge are hereby necessary for troubleshooting due to the preferred quick fastener.

A switchover can be made quickly from a multi-rotor aircraft to a winged aircraft by mechanically exchanging the drive units on the frame of the sensor unit.

### BRIEF DESCRIPTION OF THE DRAWINGS

The invention will be explained in an exemplary manner below by means of preferred embodiments.

Schematically:

FIG. 1 shows a known unmanned aircraft from the prior art

FIG. 2 shows the modular setup using the example of a quadrocopter,

FIGS. 2a-2c show different sensor systems as payload sensing systems,

FIG. 3 shows the generic system architecture for a multi-rotor aircraft,

FIG. 4 shows the generic system architecture for a winged aircraft, and

FIG. 5 shows the logical arrangement of the aircraft components.

### PREFERRED EMBODIMENTS OF THE INVENTION

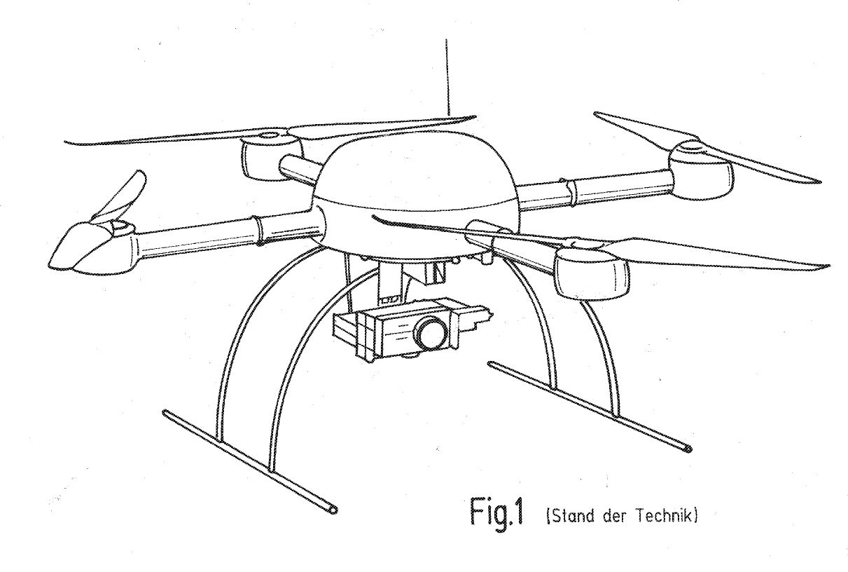

FIG. 1 shows a multi-rotor aircraft known from the prior art as unmanned aircraft, which is embodied as quadrocopter. A sensor unit in the form of a camera is positioned below the centrally arranged aircraft components in an exemplary manner.

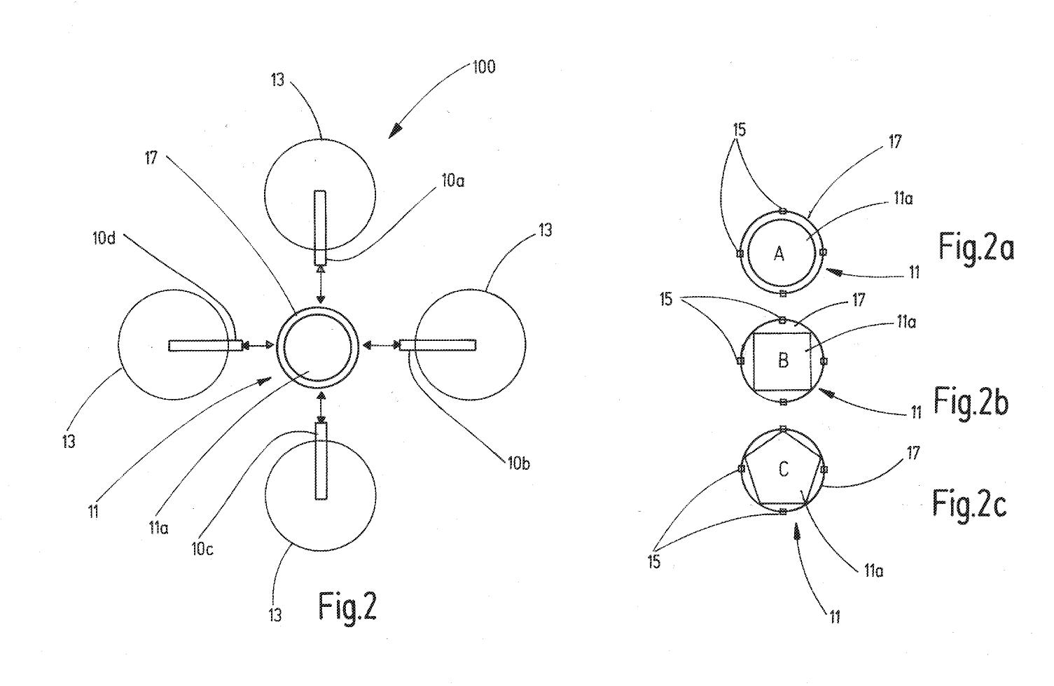

FIG. 2 schematically shows the modular setup using the example of a quadrocopter. In the center, the unmanned aircraft 100 has the payload sensing system 11. The payload sensing system 11 substantially consists of a sensor system 11a, which is arranged in and fastened to a frame 17. The rotors 13 are arranged on the drive modules 10a, 10b, 10c, 10d. The drive modules 10a, 10b, 10c, 10d can be connected to the payload sensing system 11 or to the frame 17 of the payload sensing system 11, respectively, via a plug connection. The sensor system 11a is embodied as individual optical sensor unit here for example.

The sensor system 11a can be exchanged within the frame 17 in a simple manner. Different sensor systems 11a are shown in FIGS. 2a, 2b and 2c in an exemplary manner.

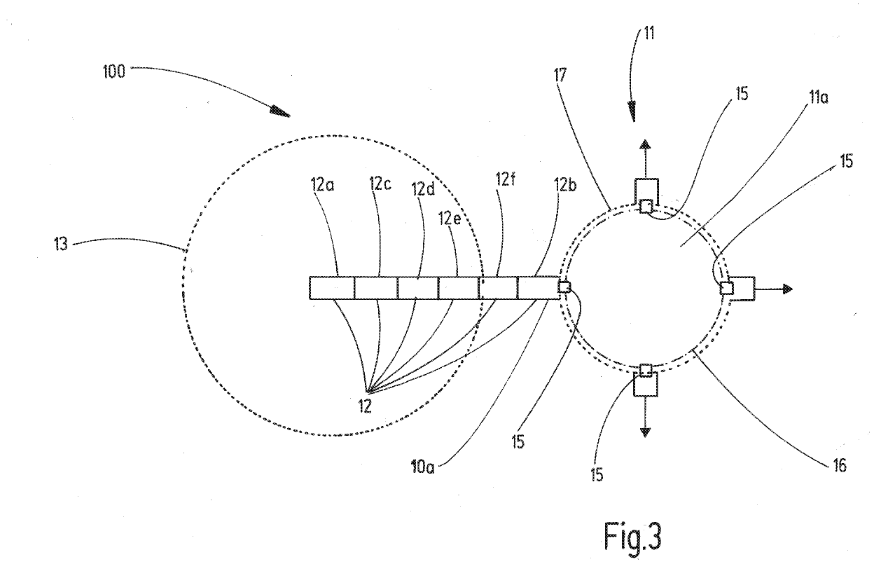

A part of the generic system architecture for an unmanned aircraft 100 is schematically shown in FIG. 3 in the form of a multi-rotor aircraft. Only the payload sensing system 11 and a drive module 10a, which is connected to the payload sensing system 11, is thereby shown in FIG. 3. The payload sensing system 11 has a plurality of coupling units 15 on the frame 17 for connecting further drive modules 10b, 10c, 10d.

The drive module 10a is embodied in the form of a rotor arm, wherein the individual aircraft components 12, namely one or a plurality of motors 12a, a power source 12b, a proximity sensor 12c, a satellite positioning system 12d, an inertial measuring system 12e and a computing unit with the possibility for wireless data transmission 12f are arranged in the interior of the rotor arm.

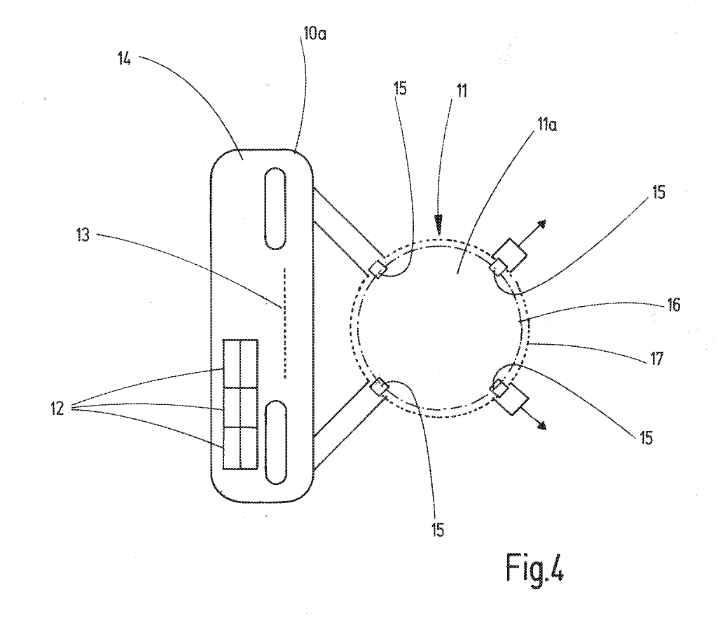

The generic system architecture for a winged aircraft configuration is shown in FIG. 4 in a schematic manner. Only one airfoil 14 is shown thereby. The payload sensing system 11 shown in FIG. 4 is connected to an airfoil 14 via the coupling units 15. The airfoil 14 thus forms a drive module 10a, 10b, 10c, 10d. The airfoil 14 or the drive module 10a, respectively, is connected to the coupling units 15 on the frame 17 of the payload sensing system 11 via connecting elements, for example arms. As does the rotor arm in FIG. 3, the airfoil 14 in FIG. 4 has the aircraft components 12.

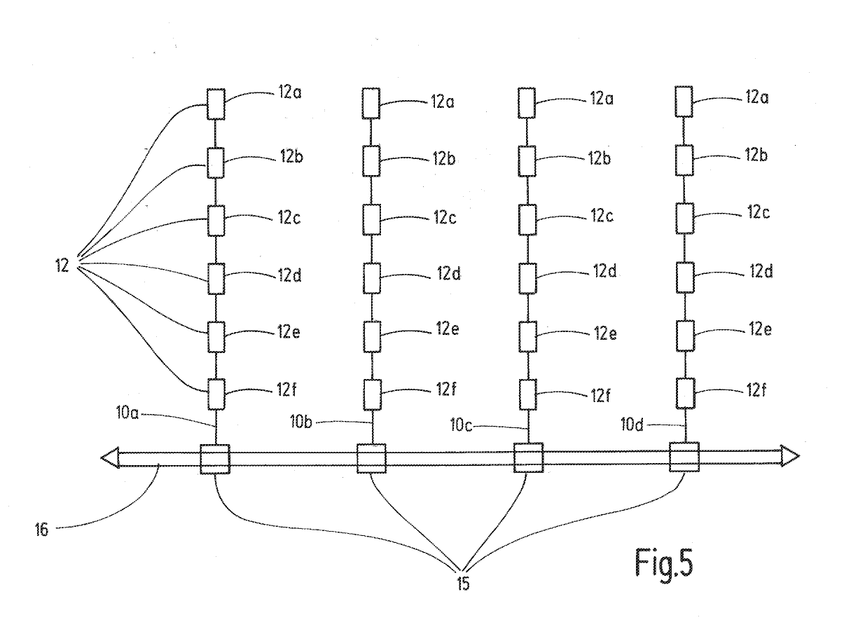

The logical arrangement of the modular aircraft components 12 is shown in FIG. 5. The individual redundant aircraft components 12 of each drive module 10a, 10b, 10c, 10d are electrically connected to one another according to their function. The drive modules 10a, 10b, 10c, 10d or the aircraft components 12, which are assigned to the drive modules 10a, 10b, 10c, 10d, respectively, are electrically connected to one another via the electric connecting means 16 in the form of a bus.

### LIST OF REFERENCE NUMERALS

100 unmanned aircraft
10a, 10b, 10c, 10d drive module
11 payload sensing system
11a sensor system
12 aircraft components
12a motor
12b power source
12c proximity sensor
12d satellite positioning system
12e inertial measuring system
12f computing unit with wireless communications unit
13 rotor
14 airfoil
15 coupling unit
16 electric connecting means
17 frame

1. An unmanned aircraft, comprising:
a plurality of drive modules arranged in a decentralized manner, wherein each drive module has a plurality of aircraft components; and
comprising a sensor system a payload sensing system including one or a plurality of sensor units, wherein the payload sensing system is centrally arranged.

2. The unmanned aircraft according to claim 1, wherein the sensor system as at least one sensor unit for the optical detection in different optical spectral ranges, for the detection of gaseous chemicals and/or for the detection of other measured variables, such as, e.g., temperature, gas pressure or also electromagnetic fields for the solid angle-resolved measured variable capturing.

3. The unmanned aircraft according to claim 1, wherein the payload sensing system in the form of the sensor system is embodied and arranged in such a way that an angle of at least 180 degrees can be captured through this in a horizontal direction as well as in vertical direction.

4. The unmanned aircraft according to claim 1, including a redundant controller.

5. The unmanned aircraft according to claim 1, wherein each drive module has identical aircraft components of the unmanned aircraft and is substantially embodied identically and modularly.

6. The unmanned aircraft according to claim 5, wherein each drive module has a motor, a power source, a proximity sensor, a satellite positioning system, an inertial measuring system, a control electronics and/or a computing unit with the possibility for wireless communication.

7. The unmanned aircraft according to claim 1, wherein the payload sensing system is functionally decoupled from the aircraft components.

8. The unmanned aircraft according to claim 1, wherein the payload sensing system has coupling units, via which the drive modules can be coupled mechanically to the payload sensing system in a simple form.

9. The unmanned aircraft according to claim 1, wherein the payload sensing system has an electric connecting means in the form of a bus system, for electrically coupling the aircraft components, which are assigned to the different drive modules.

10. The unmanned aircraft according to claim 9, wherein that the coupling units electrically couple the aircraft components of a drive module to the electric connecting means.

11. The unmanned aircraft according to claim 8, wherein the coupling units are embodied in such a way that a plurality of drive modules can in each case be coupled to the payload sensing system via a coupling unit.

12. The unmanned aircraft according to claim 1, wherein the payload sensing system has a frame, wherein the frame at least sectionally arranged around the sensor system and holds it.

13. A use of an unmanned aircraft according to claim 1, for image data capturing, measuring data capturing, object examination and/or object monitoring.

14. The unmanned aircraft according to claim 3, wherein the payload sensing system in the form of the sensor system is embodied and arranged in such a way that an angle of at least 270 degrees can be captured through this in the horizontal direction as well as in the vertical direction.

15. The unmanned aircraft according to claim 14, wherein the payload sensing system in the form of the sensor system is embodied and arranged in such a way that an angle of at least 360 degrees can be captured through this in the horizontal direction as well as in the vertical direction.
